(19) United States
(12) Patent Application Publication
(10) Pub. No.: US 2014/0330644 A1
(43) Pub. Date: Nov. 6, 2014

(54) PROMOTION IDENTIFICATION AND PRESENTATION FOR PRIOR TRANSACTIONS

(71) Applicant: BANK OF AMERICA CORPORATION, Charlotte, NC (US)

(72) Inventor: Charles Jason Burrell, Middleburg, FL (US)

(73) Assignee: BANK OF AMERICA CORPORATION, CHARLOTTE, NC (US)

(21) Appl. No.: 13/875,994

(22) Filed: May 2, 2013

(51) Int. Cl. G06Q 30/02

(52) U.S. Cl. CPC G06Q 30/0255
USPC 705/14.53

(57) ABSTRACT

Embodiments of the invention are directed to a system, method, or computer program product for providing post-transaction receipt collection and product promotion monitoring. As such, receipts associated with a user transaction may be collected and the products from those receipts may be determined. Subsequently, the invention may monitor promotions from merchants that are associated with the products of the transaction. In this way, the invention monitors for promotions, such as coupons or discounts, associated with products of a past transaction. If a match between a promotion and a product is made, the system may compare the match to pre-established rules. If the pre-established rules are not triggered, the invention may provide the user with a notification that an eligible promotion exists for a product that he/she has previously purchased. In this way, the user may be able utilize the current promotion for a previously purchased product.

### BACKGROUND

In today's market place, there may be several merchants providing the same or similar products to a customer. Once a customer has determined a product to purchase the customers may have several brands or types of that product to purchase from. Moreover, the customer may be able to purchase a product from several merchants.

Selection of the merchant, brand, and payment vehicle to complete the transaction for the product are all unique selections based on the customer. Once the customer has completed the transaction and applied the selected payment vehicle to the transaction, the customer may receive a purchase receipt for the transaction. Post transaction, the customer may return the product or utilize the product for its intended purpose.

### BRIEF SUMMARY

Embodiments of the present invention address the above needs and/or achieve other advantages by providing apparatuses (e.g., a system, computer program product and/or other devices) and methods for providing post-transaction receipt collection and product promotion monitoring. As such, after a user has purchased a product, the system may collect the receipt. The receipt may provide the system with information about the transaction, such as, but not limited to the merchant of the transaction, the payment vehicle used for the transaction, information associated with the products of the transaction, the purchase price of each product of the transaction, and the like.

In some embodiments, the system may receive an indication of a transaction being completed between a merchant and a user. Once a transaction has been completed, a receipt may be issued by the merchant. The system may collect the receipt from the merchant or the user. This collection may be manually or automatic.

Once the receipt has been collected by the system, the system may identify information about the transaction, such as, but not limited to the merchant of the transaction, the payment vehicle used for the transaction, information associated with the products of the transaction, the purchase price of each product of the transaction, and the like from the collected receipt. In some embodiments, specific details of the product, such as the price, brand, type, model, or the like may be determined. This information may be obtained from the stock keeping unit (SKU) data, merchant codes, identification numbers/letters, or the like associated with the receipt. SKU data may be a unique identifier or code that refers to the products associated with a merchant.

In some embodiments, once the information about the transaction has been determined, if necessary, the system may determine the confidence associated with the identification of the products of the transaction. In this way, the system may determine a confidence for each product of the transaction. This will be the confidence that the product identified from the collected receipt is a specific model, price, brand, place of manufacturing, and the like. A confidence may be generated because the receipt information may not be detailed enough to identify down to the model number for each product. Furthermore, the receipt information may be limited such that the exact model number, brand, or the like of the products of the transaction may not be identified by the system.

In some embodiments, the system may confirm with the user the product, brand, price, and the like associated with the transaction. In this way, if the confidence is too low, the system may confirm the proper products of the transaction with the user.

Once the products of the transaction have been identified with a degree of confidence, the system may monitor for post transaction promotions and/or changes associated with the products of the transaction. In some embodiments the promotions and/or changes may include one or more discounts, coupons, rebates, incentives, or the like offered for the product. This monitoring may include one or more of monitoring advertisements, merchants, manufactures, warehouses, or the like that may be associated with the product. The monitoring may be online or offline monitoring.

In some embodiments, the monitoring may be limited to monitoring for a specific time period after the transaction, specific products, for specific merchants, or the like. These limitations may be rules based, set up either automatically or manually. These rules may ensure that the product of the transaction may still be eligible for the post transaction promotion. Rules may include time based rules, product based rules, or merchant based rules. As such, the user may be able to present his/her receipt for the product and receive the new promotional price for the product. In this way, rules may include time periods for product return/exchange eligibility, such that if a product was purchased thirty/sixty/ninety days ago, it may not be eligible for a return or promotion price match. Rules may include product based rules, such as if a product is not eligible for a return at any point. Rules may also include merchant based rules, such that the merchant promotions monitored may be merchants that will accept a return or exchange for the product of the transaction. This may be the same merchant of the transaction or a separate merchant that accepts price matching or the like.

In some embodiments, the system may determine the significance of the product promotion. The significance of the promotion may determine if the user should be notified of the promotion. For example, the significance may be based on how great the financial impact associated with the promotion. If the user may save a large amount of money because of the promotion, it will be weighed as significant. If the user may save very little because of the promotion, it will be weighed as less significant.

Finally, upon identification of a promotion associated with a product of the transaction, the system may notify the user of the promotion. In this way, the user may be able to return or exchange the product of the prior transaction for the same or similar product associated with the promotion. For example, a user may have bought Television A for XXX.XX dollars. A promotion for a percentage off a purchase of Television A may have been identified by the system and presented to the user. As such, the user may return or exchange his/her Television A for the Television A with the promotion for a percentage off. Therefore allowing the user to receive the benefit of a post transaction promotion by a merchant.

Embodiments of the invention relate to systems, methods, and computer program products for collecting receipts from transactions between a user and a merchant, wherein the receipts are collected post-transaction; determining one or more products of the transactions, wherein the one or more products are determined to be products of the transaction based on the collected receipts; monitoring, continuously, merchants for promotions associated with the one or more products of the transaction; identifying a promotion that corresponds to the one or more products of the transactions; determining if the identified promotion is eligible for use for the one or more products of the transaction, wherein eligibility includes a capability to use the identified promotion after the transaction between the user and the merchant has taken place; and notifying the user of an eligible promotion and the one or more merchants that accept the eligible promotion.

In some embodiments, determining that the identified promotion is eligible for use at one or more merchants for the one or more products of the transaction further comprises determining if the one or more merchants accept utilization of the identified promotion after the one or more products have been purchased.

In some embodiments, the invention further comprises allowing the user to enroll, wherein enrollment authorizes the collection of receipts from transactions between the user and the merchant, wherein enrollment further comprises allowing setting up rules for notification of the user of eligible promotions.

In some embodiments, determining if the identified promotion is eligible for use for the one or more products of the transaction further comprises determining if the identified promotions satisfy rules, wherein the rules include one or more: merchant based rules, wherein merchant based rules are rules established by merchant policy that determine if the identified promotion can be used after the transaction between the user and the merchant; time based rules, wherein time based rules are rules that determine if the identified promotion can be used based on an amount of time that has passed since the transaction between the user and the merchant; or product based rules, wherein product based rules are rules that determine if the one or more of the products of the transaction are eligible for promotions after the transaction between the user and the merchant has occurred.

In some embodiments, collecting receipts from transactions between a user and a merchant comprises receiving or retrieving receipts electrically from the user or the merchant via image capture.

In some embodiments, determining one or more products of the transaction further comprises identifying the one or more product using a stock keeping unit on the collected receipts.

In some embodiments, determining one or more products of the transaction further comprises determining a confidence score that the one or more products of the transaction determined from the collected receipts are a type, brand, and model of a real product of the transaction, wherein if the confidence is not high enough the user is contacted to confirm the type, brand, and model of the one or more products of the transaction.

In some embodiments, monitoring merchants for promotions associated with the one or more products of the transaction further comprises monitoring the merchant of the transaction and other merchants that promote the one or more products of the transaction.

In some embodiments, promotions comprise a discount in the price of the product of the transaction between the user and the merchant.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating the post-transaction receipt collection and product promotion monitoring process, in accordance with one embodiment of the present invention;

FIG. 2 provides a post-transaction receipt collection and product promotion monitoring system environment, in accordance with one embodiment of the present invention;

FIG. 3 provides a process map illustrating a post-transaction receipt collection and product promotion monitoring set up process, in accordance with one embodiment of the present invention;

FIG. 4 provides a process map illustrating the post-transaction receipt collection and product promotion monitoring process, in accordance with one embodiment of the present invention;

FIG. 5 provides a process map illustrating the collection of user receipts associated with user transactions for the post-transaction receipt collection and product promotion monitoring, in accordance with one embodiment of the present invention;

FIG. 6 provides a process map illustrating rules input and application for the post-transaction receipt collection and product promotion monitoring, in accordance with one embodiment of the present invention; and

FIG. 7 provides a decision map illustrating the user's implementation of the post-transaction receipt collection and product promotion monitoring process, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Furthermore, the term “product” as used herein may include any product, service, or the like that may be purchased or obtained from a merchant. The term “promotion” as used herein may refer to one or more discounts, coupons, rebates, incentives, or the like offered for the product. Promotions may also include any changes in the price of the product from the date of purchase whether that price change will be an increase or decrease.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to users.

Some portions of this disclosure are written in terms of a financial institution's unique position with respect to user transactions. As such, a financial institution may be able to utilize its unique position to receive, store, process, and retrieve information associated with receipts from transaction and/or promotions.

The embodiments described herein may refer to the use of a transaction, transaction event or point of transaction event to trigger the steps, functions, routines, or the like described herein. In various embodiments, occurrence of a transaction triggers the sending of information such as offers and the like. Unless specifically limited by the context, a “transaction”, “transaction event” or “point of transaction event” refers to any communication between the user and the merchant, e.g. financial institution, or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's mobile device establishes a wireless connection, such as a Wi-Fi connection, with a point-of-sale (or point-of-transaction) terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

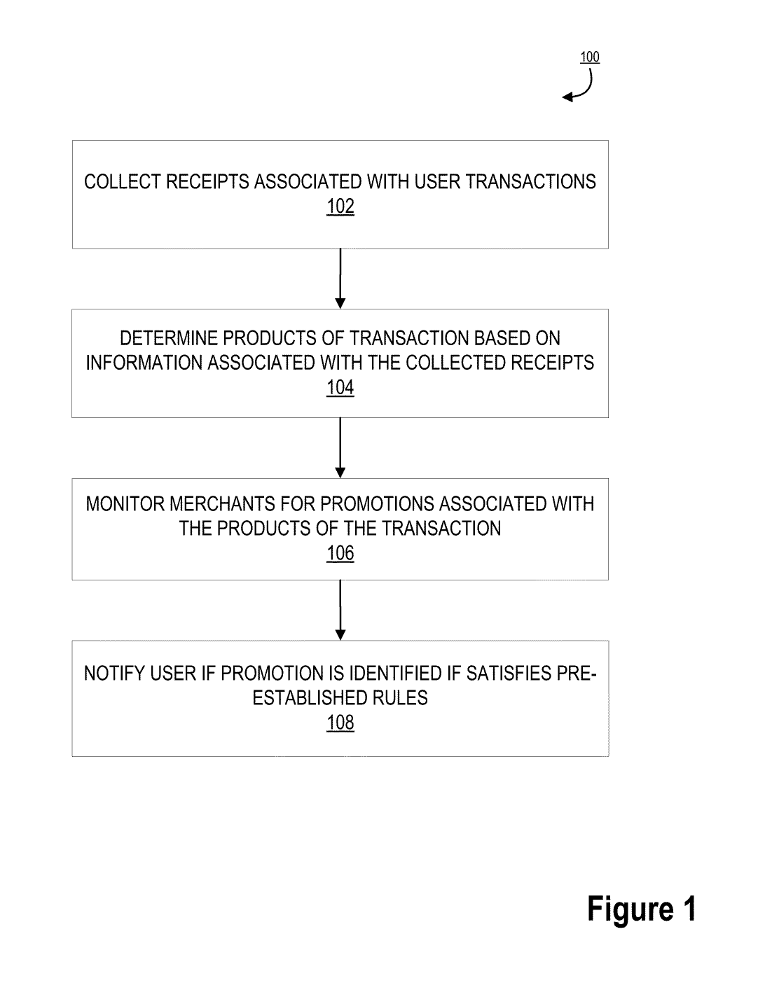

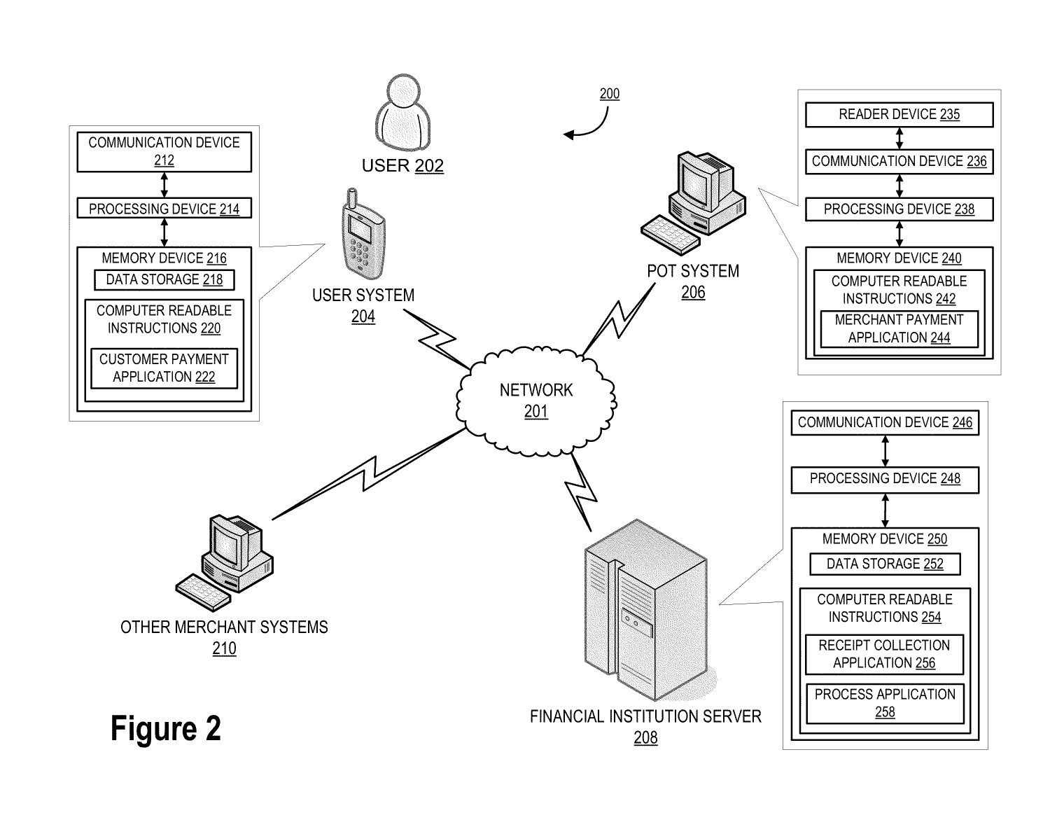

FIG. 1 illustrates a high level process flow for the post-transaction receipt collection and product promotion monitoring process 100, in accordance with one embodiment of the present invention, which will be discussed in further detail throughout this specification with respect to FIG. 2 through FIG. 7. The first step in the process 100, as illustrated in block 102, is to collect receipts associated with user transactions. A user, as used herein may include, but is not limited to, a user, individual, person, entity, or other individual that may enter into a transaction with a merchant. The receipts may be associated with a transaction, such as a return, purchase, or other type of transactions. The types of transaction may be online, offline, at a brick and mortar store location, over the phone, or the like. The transaction may be for a product, service, or the like.

Next, the system may determine the products of the transaction based on information associated with the transaction associated with the collected receipts, as illustrated in block 104. In this way, the system may identify specific information about the transaction from the receipt. The information associated with the transaction may include, but not limited to the merchant of the transaction, the payment vehicle used for the transaction, information associated with the products of the transaction, the purchase price of each product of the transaction, and the like from the collected receipt. As such, specific details associated with the products of the transaction, such as brand, type, price, or the like may be identified.

Next, the system may monitor merchants for promotions associated with the products of the transaction, as illustrated in block 106. In some embodiments the promotions may include one or more discounts, coupons, rebates, incentives, or other changes in price associated with the products of the transaction. This monitoring may include one or more of monitoring advertisements, merchants, manufactures, warehouses, or the like that may be associated with the product. The monitoring may be online or offline monitoring.

Finally, as illustrated in block 108, the process may include by providing the user with notification if a promotion is identified. The promotion may be presented if qualified within pre-determined rules.

FIG. 2 provides a post-transaction receipt collection and product promotion monitoring system environment 200, in accordance with one embodiment of the present invention. As illustrated in FIG. 2, the financial institution server 208 is operatively coupled, via a network 201 to the user system 204, to the point-of-transaction (POT) system 206, and to other merchant systems 210. In this way, the financial institution server 208 can send information to and receive information from the user system 204, the POT system 206, and other merchant systems 210, to collect receipts and monitor product promotion associated with a transaction between a user 202 and a merchant. FIG. 2 illustrates only one example of an embodiment of a post-transaction receipt collection and product promotion monitoring system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual making a transaction with a merchant. The transaction may be made at a POT system 206 of a merchant, online or offline, over the phone, at the merchant's place of business and/or other transaction means. The purchase may be made by the user 202 using a user system 204, such as a mobile wallet (i.e. smart phone, PDA, and the like) or other types of payment systems that communicate with POS systems 206 and/or financial institution servers 208 to allow the user 202 to provide input, provide receipts, and/or receive notifications regarding promotions. In some embodiments, the user 202 may be a merchant or a person, employee, agent, independent contractor, and the like acting on behalf of the merchant to enter into a transaction.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the POT system 206, the user system 204, and the other merchant systems 210. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a process application 258. In some embodiments, the computer-readable instructions 254 include a receipt collection application 256. In some embodiments, the memory device 250 includes data storage 252 for storing data related to the post-transaction receipt collection and product promotion monitoring system including but not limited to data created and/or used by the process application 258 and/or the receipt collection application 256.

In the embodiment illustrated in FIG. 2 and described throughout much of this specification, the process application 258 may identify a user 202 enrollment (including user 202 rule preferences), determine products of a transaction based on the receipt, monitor merchants for product promotions, recognize and match promotions with products of a receipt, determine confidences associated with the match, determine product promotion eligibility, and notify users 202.

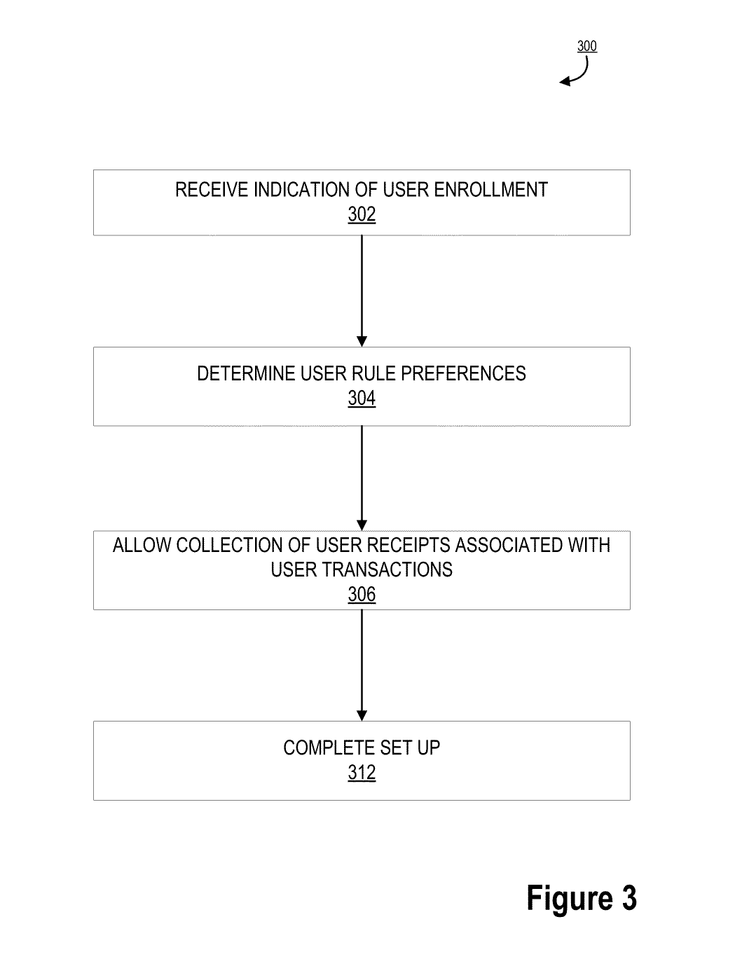

First, the process application 258 may identify a user 202 enrollment. User enrollment is discussed in more detail below with respect to FIG. 3. The user 202 may enroll in the post-transaction receipt collection and product promotion monitoring system online or offline via selecting the program. In some embodiments, this enrollment may be via an application, online banking interface, website, mail, telephone call, text message, or the like. Furthermore, during enrollment the system may receive user 202 rules, such as those based on time, product, or merchant.

Once enrolled, in some embodiments, the system may receive an indication of a transaction being completed between a merchant and a user 202. Once a transaction has been completed, a receipt may be issued by the merchant. The receipt collection application 256 may receive and/or collect the receipt. In some embodiments, the system may automatically receive/collect the receipt from the merchant. In some embodiments, the system may automatically receive/collect the receipt from the user 202. In some embodiments, the system may request the receipt from the merchant. In some embodiments, the system may request the receipt from the user 202. In yet other embodiments, the user 202 may manually provide the receipt to the system.

Next, the process application 258 may determine the products of the transaction based on the receipt. The process application 258 may determine the products of the transaction by utilizing the information on the collected receipt. This information may include the stock keeping unit (SKU) data, merchant codes, identification numbers/letters, or the like associated with the receipt. SKU data may be a unique identifier or code that refers to the products associated with a merchant. In this way, the process application 258 may be able to determine specific information about the products of the transaction, such as the type, brand, price, category, or the like. Furthermore, the process application 258 may be able to identify other information about the transaction, such as, but not limited to the merchant of the transaction, the payment vehicle used for the transaction, and the like from the collected receipt.

Once the products are identified, the process application 258 may determine a confidence value for the identification. In this way, the process application 258 may determine the confidence of the identification, such that the process application 258 may be confidence that it identified the product of the receipt with accuracy. If confidence is low, the process application 258 may communicate with the user system 204 and/or the POT system 206, via the network 201 to confirm the identity of the product.

Next, the process application 258 may monitor the merchants for product promotions associated with the products of the collected receipts. In some embodiments the promotions may include one or more discounts, coupons, rebates, incentives, or the like offered for the product. This monitoring may include one or more of monitoring advertisements, merchants, manufactures, warehouses, or the like that may be associated with the product. The monitoring may be online or offline monitoring. The process application 258 may monitor based on rules determined by the process application 258 and/or provided by the user 202. These rules are discussed in further detail below. In this way, the process application 258 may determine rules, such as merchant based rules, time based rules, product based rules, or the like based on merchant or product eligibility for return/exchange post transaction.

The process application 258 may then recognize and match promotions with the products identified in the receipt. Again, as with above, the process application 258 may determine the confidence associated with the match. Because there may be limited information associated with the promotions that were found, the process application 258 determines a confidence that the promotion matches a product of the receipt.

After confirming the confidence of the matched promotion. The process application 258 ensures that the matched promotion satisfies the rules established by the process application 258 and/or the user 202.

Finally, the process application 258 provides notification to the users 202 of the promotion found for one or more products of the receipt. In this way, the user 202 may be able to return or exchange the product of the prior transaction for the same or similar product associated with the promotion, thus the user 202 may receive the benefit of a promotion posted after the product was purchased. This notification may be sent from the processing application 258 to the user 202 via network 201 communication between the financial institution server 208 and the user system 204.

In the embodiment illustrated in FIG. 2 the financial institution server 208 further comprises a receipt collection application 256. The receipt collection application 256 allows for collection and storage of receipts associated with user 202 transactions. As such, the receipt collection application 256 may receive receipt information from the other systems on the network through the communication device 246 to store the receipt, post-transaction.

In some embodiments, the receipt collection application 256 may collect receipts associated with any transaction that includes a user 202. Once a user 202 is enrolled in the process, the receipt collection application 256 may periodically receive receipts associated with the transaction. In other embodiments, the receipt collection application 256 may also request receipts associated with user 202 transactions.

In some embodiments, the system may automatically receive the receipt from the merchant. In this way, the POT system 206 may recognize that the user 202 is enrolled in the program. As such, once a transaction has been completed between a user 202 and a merchant associated with the POT system 206, the POT system 206 may automatically, via the network 201, provide the receipt collection application 256 with a receipt associated with that particular transaction. In some embodiments, the system may automatically receive the receipt from the user 202. In this way, once a transaction has been completed between the user 202 and a merchant, the user system 204 may recognize that the user 202 has been enrolled in the process. As such, the user system 204 may automatically send the receipt to the receipt collection application 256 via the network 201.

In some embodiments, the user system 204 may be set up to automatically send any receipts that the user system 204 receives directly to the receipt collection application 256. In this way, the user system 204 may receive an electronic receipt via email from a merchant. The user system 204 may recognize the email being a receipt and automatically forward the electronic receipt to the receipt collection application 256.

In some embodiments, the receipt collection application 256 may receive the receipts via manual input from either the merchant or user 202. The user 202 may provide the receipt collection application 256 with receipts via email, text message, image capturing, or the like. In this way, the user 202 may be able to take a picture of a receipt of a transaction. Subsequently, utilizing the user system 204, the user 202 may be able to send an image copy of the receipt to the receipt collection application 256, via the network 201.

In some embodiments, the receipt collection application 256 may request receipts associated with a user 202 transaction. In this way, the receipt collection application 256 may determine that a user 202 has entered into a transaction. Once determined, the receipt collection application 256 may request a receipt for the transaction from the user 202 or the merchant. For example, the receipt collection application 256 may identify that the user 202 has enrolled in the process, but no receipt has been received for the transaction. The identification may be based on the payment method being identified by the financial institution server 208 associated with the receipt collection application 256, based on the financial institution server 208 potential processing of the transaction. As such, the receipt collection application 256 may request a receipt be sent from the user 202 or the merchant if the receipt collection application 256 identifies that a transaction involving the merchant has taken place.

Next, the receipt collection application 256 may collect the received or requested receipts and store them in a repository. Once in the repository, the products of the receipts may be identified and product promotion associated with the same may be monitored.

As illustrated in FIG. 2, the POT system 206 generally comprises a reading device 235, a communication device 236, a processing device 238, and a memory device 240. The reading device 235 is operatively coupled to the processing device 238, communication device 236, and the memory device 240. The POT system 206 may include a reader device 235 to receive payment vehicle information from the user 202 through the user system 204 and/or other payment devices. Such a reader device 235 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 235 receives information that may be used to identify the consumer's payment vehicle and/or transaction data at the POT system 206 and communicates the information via the communication device 236 over a network 201, to other systems such as, but not limited to the financial institution server 208, other merchant systems 210, and/or the user system 204. As such, the communication device 236 generally comprises a modem, server, or other device for communicating with other devices on the network 201.

As further illustrated in FIG. 2, the POT system 206 comprises computer-readable instructions 242 stored in the memory device 240, which in one embodiment includes the computer-readable instructions 242 of a merchant payment application 244.

In the embodiment illustrated in FIG. 2, the merchant payment application 244 allows the POT system 206 to be linked to the financial institution server 208 to communicate, via a network 201, the information related to the transaction being made such as communicating an electronic receipt associated with the transaction and/or communicating merchant promotions. Furthermore, the merchant payment application 244 may be able to receive communications from the financial institution server 208 such as requests for receipts or the like.

FIG. 2 also illustrates a user system 204. The user system 204 generally comprises a communication device 212, a processing device 214, and a memory device 216. The user system 204 is a computing system that may allow a user 202 to send receipts to the financial institution server 208, enter into transactions with the POT system 206, inputted rules for the post-transaction receipt collection and product promotion monitoring process, and receive notifications regarding promotions for products. The processing device 214 is operatively coupled to the communication device 212 and the memory device 216. The processing device 214 uses the communication device 212 to communicate with the network 201 and other devices on the network 201, such as, but not limited to the POT system 206, the financial institution server 208, and the other merchant systems 210. As such, the communication device 212 generally comprises a modem, server, or other device for communicating with other devices on the network 201.

As further illustrated in FIG. 2, the user system 204 comprises computer-readable instructions 220 which in one embodiment includes the computer-readable instructions 220 of a user payment application 222. The user payment application 222 allows for a user 202 to send receipts to the financial institution server 208, enter into transactions with the POT system 206, inputted rules for the post-transaction receipt collection and product promotion monitoring process, and receive notifications regarding promotions for products. The user system 204 may be, for example, a desktop personal computer, a mobile system, such as a cellular phone, smart phone, personal data assistant (PDA), laptop, or the like. Although only a single user system 204 is depicted in FIG. 2, the payment account determination system environment 200 may contain numerous user systems 204.

The other merchant systems 210 are operatively coupled to the financial institution server 208, the POT system 206, and/or the user system 204 through the network 201. The other merchant systems 210 have systems with devices the same or similar to the devices described for the financial institution server 208, the POT system 206, and/or the user system 204 (i.e., communication device, processing device, and memory device). Therefore, the other merchant systems 210 communicate with the financial institution server 208, the POT system 206, and/or the user system 204 in the same or similar way as previously described with respect to each system. The other merchant systems 210, in some embodiments, are comprised of systems and devices that allow the user 202 and the financial institution server 208 to access prior transaction receipts associated with a user 202 at that other merchant, promotions associated with products at the other merchant, and rules associated with returns/exchanges at the other merchant.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 3 illustrates a process map for the set-up of a post-transaction receipt collection and product promotion monitoring process 300, in accordance with one embodiment of the present invention. First, as illustrated in block 302 the process 300 may be initiated when a user 202 enrolls in the process 300. The user 202 may be able to enroll in the program by selecting an application, a link, manually, or the like. An application may be selected by the user 202 which is provided by the financial institution to download an application on the user system 204 or to enroll through an online banking application provided by the financial institution. In some embodiments, the user 202 may also manually select enrollment into the process 300, such as via mail, email, text message, or other ways of enrolling into a process.

Next, as illustrated in block 304 the user rule preferences may be determined. These notifications may be provided by the user 202 during set-up that aid the system in determining the product promotions to present to the user 202. These rules may include one or more rules based on time, product, or merchant. For example, time of promotion after the transaction, promotion amount, product type, merchant, or the like. In some embodiments, the time rule may allow a user 202 to set a rule for the system to only monitor product promotions for a specific amount of time, such as days/weeks/months. In some embodiments, the promotion amount may set a rule for the system to only notify the user 202 of promotions post-transaction that are over a specific amount or percentage off of what the user 202 purchased the product for. In some embodiments, the user 202 may set a rule for the system to only notify him/her of product promotions based on a product type and/or merchant. These rules may be set up either automatically or manually. In some embodiments, the user 202 may set the rules. In other embodiments, the system may set the rules. These rules may ensure that the product of the transaction may still be eligible for the post transaction promotion.

Next, as illustrated in block 306 of FIG. 3, the set-up process 300 continues by allowing for the collection of user 202 receipts associated with transactions. As such, once the user 202 has enrolled, each receipt from each transaction of a user 202 may be either manually or automatically provided to the system for port-transaction receipt collection and product promotion monitoring. Finally, as illustrated in block 312, the set-up process 300 is completed.

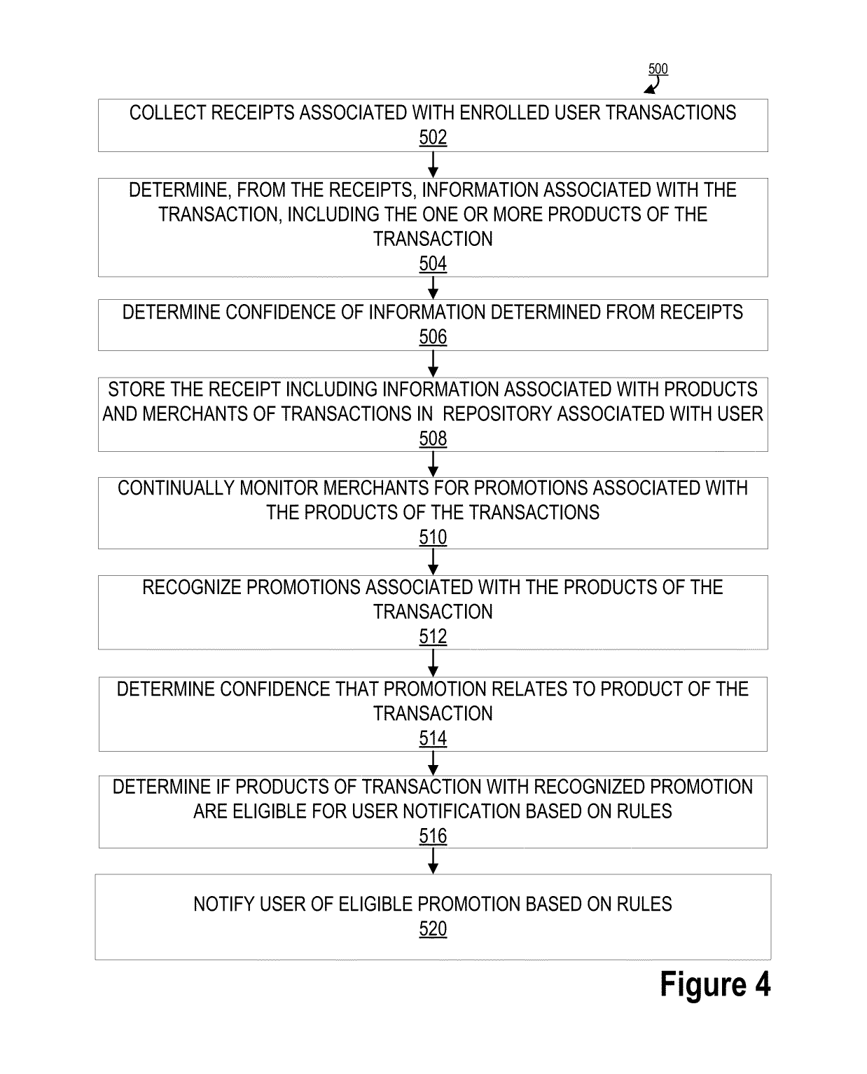

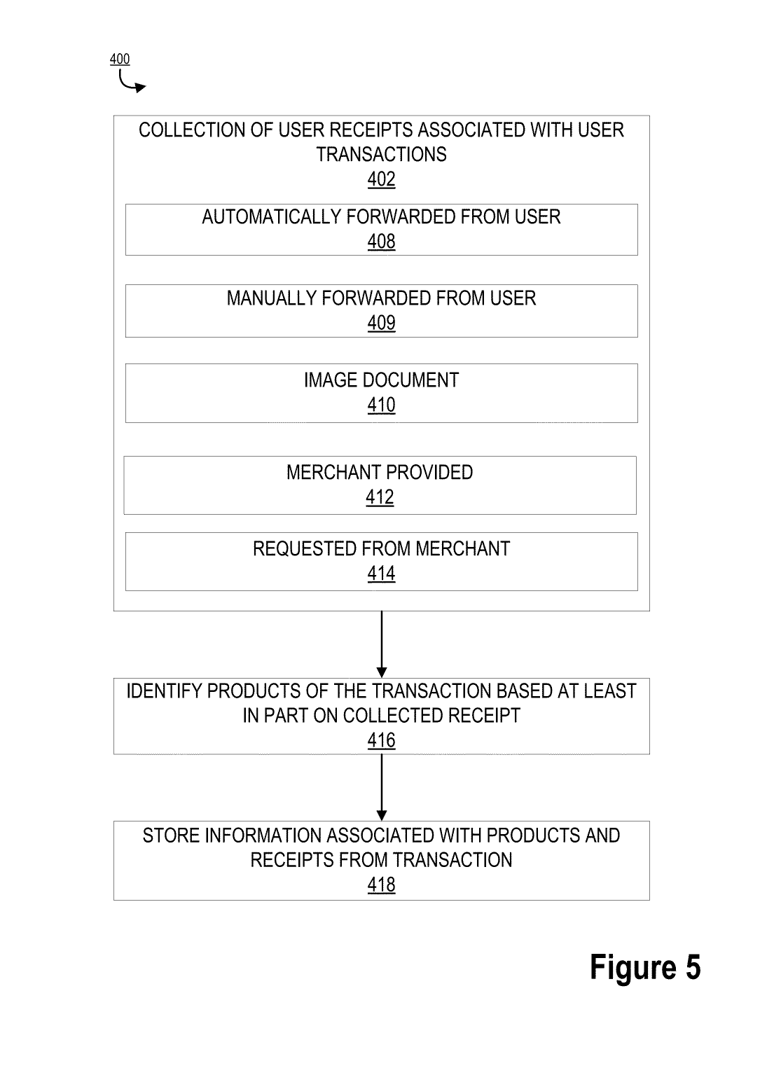

FIG. 4 provides a process map illustrating the post-transaction receipt collection and product promotion monitoring process 500, in accordance with one embodiment of the present invention. The process 500 is initiated when a user 202 enrolls and sets-up his/her post-transaction receipt collection and product promotion monitoring program, which is described above with respect to FIG. 3. Next, the user 202 may enter into a transaction with a merchant. Once the transaction is completed, the system may collect receipts associated with the enrolled user 202 transaction with the merchant, as illustrated in block 502. In this way, once a transaction has been completed, a receipt may be issued by the merchant for the transaction. The system may then collect the receipt, as illustrated in block 502. In some embodiments, the system may automatically receive the receipt from the merchant. In some embodiments, the system may automatically receive the receipt from the user 202. In some embodiments, the system may request the receipt from the merchant. In some embodiments, the system may request the receipt from the user 202. In yet other embodiments, the user 202 may manually provide the receipt to the system. The collection of receipts is discussed in more detail below with respect to FIG. 5.

Next, as illustrated in block 504 of FIG. 4 the system continues to determine, from the receipts, one or more products and merchants associated with the transaction. As such, the system may identify information about the transaction, such as, but not limited to the merchant of the transaction, the payment vehicle used for the transaction, information associated with the products of the transaction, the purchase price of each product of the transaction, and the like from the collected receipt. This information may be obtained from the stock keeping unit (SKU) data, merchant codes, identification numbers/letters, or the like associated with the receipt. SKU data may be a unique identifier or code that refers to the products associated with a merchant.

Once information about the products of the transaction is determined in block 504, the system may determine a confidence of the determined information, as illustrated in block 506. As such, in some embodiments, once the information about the transaction has been determined in block 504, if necessary, the system may determine the confidence of the information, as illustrated in block 506. In this way, the system may determine a confidence for each product of the transaction. This will be the confidence that the product identified from the collected receipt is a specific model, price, brand, place of manufacturing, and the like. A confidence may be generated because the receipt information may not be detailed enough to identify down to the model number for each product. Furthermore, the receipt information may be limited such that the exact model number, brand, or the like of the products of the transaction may not be identified by the system. In some embodiments, the system may confirm with the user 202 the product, brand, price, and the like associated with the transaction. In this way, if the confidence is too low, the system may confirm the proper products of the transaction with the user 202.

Next, as illustrated in block 508, the system may store the receipt, including information associated with the products and merchants of the transaction in a repository. This storage may be in a repository associated with the enrolled user 202.

As illustrated in block 510, the system may continually monitor merchants for promotions associated with the products of the transaction. As such, once the products of the transaction have been identified with a degree of confidence in block 506 and stored in block 508, the system may monitor for post-transaction promotions and/or changes associated with the products of the transaction. In some embodiments, the promotions and/or changes may include one or more discounts, coupons, rebates, incentives, or the like offered for the product. This monitoring may include one or more of monitoring advertisements, merchants, manufactures, warehouses, or the like that may be associated with the product. The monitoring may be online or offline monitoring.

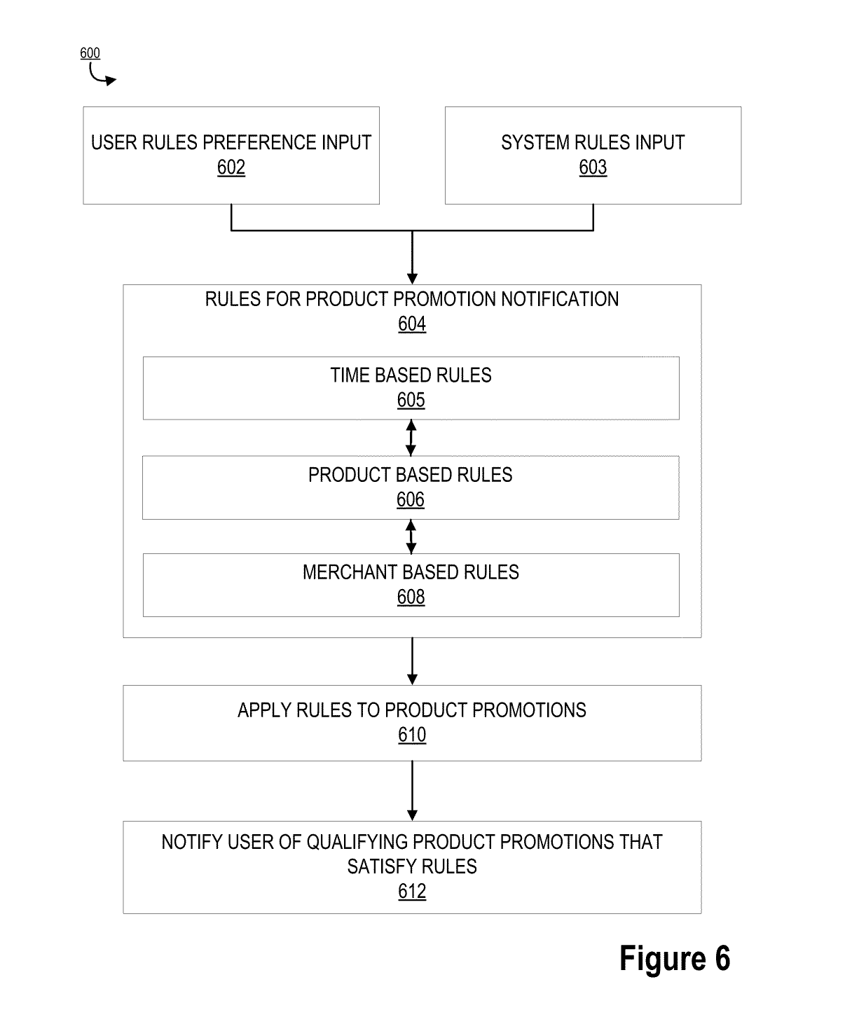

In some embodiments, the monitoring may be limited to monitoring for a specific time period after the transaction, specific products, for specific merchants, or the like. These limitations may be rules based, set up either automatically or manually. Rules set-up and implication is discussed in further detail below with respect to FIG. 6. In some embodiments, the user 202 may set the rules. In other embodiments, the system may set the rules. These rules may ensure that the product of the transaction may still be eligible for the post transaction promotion. Rules may include time based rules, product based rules, or merchant based rules.

During the monitoring, in some embodiments, the system may recognize promotions associated with the products of the transaction, as illustrated in block 512. These promotions may be from one or more merchants for products that the user 202 has previously purchased. In this way, the system may recognize discounts or the likes associated with a product that the user 202 has previously purchased. In this way, the system identified promotions associated with products that the user 202 has purchased.

Once the promotions associated with one or more products of a user 202 transaction are identified in block 512, the system may determine a confidence that the promotion relates to the products of the transaction, as illustrated in block 514. Similar to block 506 above, the system may determine the confidence that the promotion is associated with a product of the user's past transaction. This confidence is the confidence that the product identified from the collected receipt is the specific model, brand, manufacturer, or the like that is the same product of the identified promotion.

Next, as illustrated in block 516, the system may determine if the products of the transaction are eligible for user 202 notification based on rules. As illustrated below in FIG. 6, the system and/or user 202 may provide rules for the monitoring and/or notification of promotions associated with products of user 202 transactions. These rules may ensure that the product of the transaction may still be eligible for the post transaction promotion. Rules may include time based rules, product based rules, or merchant based rules.

Finally, as illustrated in block 520, the system may notify the user 202 of promotions that where eligible for notification based on the rules. As such, upon identification of a promotion associated with a product of the transaction, the system may notify the user 202 of the promotion, as illustrated in block 520. In this way, the user 202 may be able to return or exchange the product of the prior transaction for the same or similar product associated with the promotion. For example, a user 202 may have bought Television A for XXX.XX dollars. A promotion for a percentage off a purchase of Television A may have been identified by the system and presented to the user. As such, the user 202 may return or exchange his/her Television A for the Television A with the promotion for a percentage off. Therefore allowing the user 202 to receive the benefit of a post transaction promotion by a merchant.

FIG. 5 illustrates a process map for the collection of user 202 receipts associated with user 202 transactions for the post-transaction receipt collection and product promotion monitoring 400, in accordance with one embodiment of the present invention. As illustrated in block 402, the ways of collection of user 202 receipts associated with a user 202 transaction are detailed. These collection means include automatically forwarded from the user 408, manually forwarded from user 202, image document 410, merchant provided 412, or requested from merchant 414. As such, once a user 202 is enrolled in the post-transaction receipt collection and product promotion monitoring process, the system may periodically collect and/or receive receipts associated with user transactions. As illustrated in block 408, the user 202 receipts may be automatically forwarded from the user 202 for collection. In this way, the user 202 may be set up to automatically send any receipts for transactions directly to the system. For example, the user may receive electronic receipts associated with a transaction via text message, email, voice message, or the like. The user system 204 that receives the electronic receipt may automatically forward the receipt to the system for review and retention.

As illustrated in block 409, the user 202 may manually forward receipts for collection. In this way, the user 202 may provide the system with his/her transaction receipts via email, text message, standard mail, voice message, image capturing, or the like. As such, the user 202 may be able to communicate with the system in various ways in order to provide the system with electronic receipts, copies of receipts, or authentic receipts for transactions the user 202 has entered into. In some embodiments, the user 202 manual input may include providing image documents to the system, as illustrated in block 410. In this way, the user 202 may be able to take a picture or image document of a receipt of a transaction. Subsequently, the user 202 may be able to send an image copy of the receipt to the system for review and retention.

As illustrated in block 412, the merchant may provide the receipt of a transaction between the user 202 and the merchant to the system for the post-transaction receipt collection and product promotion monitoring process. In some embodiments, the merchant may provide the receipt to the system, as illustrated in block 412. In some embodiments, this may be based on a request from a user 202. In this way, the user 202 may request, during or after the transaction, that the merchant provide the system with an electronic receipt of the transaction that just occurred between the user 202 and the merchant. In other embodiments, the system may automatically receive the receipt from the merchant. In this way, the merchant may recognize that the user 202 is enrolled in the program. As such, once a transaction has been completed between a user 202 and a merchant, the merchant may automatically send an electronic receipt to the system associated with that particular transaction.

In yet other embodiments, the system may request the receipt from the merchant, as illustrated in block 414. In this way, system may determine that a user 202 has entered into a transaction. Once determined, the system may request a receipt for the transaction from the merchant. For example, the system may identify that the user 202 has enrolled in the process and that a transaction has occurred, but no receipt has been received for the transaction. The identification of the transaction occurring may be based on the financial institution may process the transition. As such, the system may request a receipt be sent from the merchant if the system has identified that a transaction involving the user 202 and the merchant has taken place.

Once the user 202 receipts have been collected in block 402, the system may identify products of the transaction based at least in part on the collected receipts, as illustrated in block 416. The products of the transaction may be identified via the stock keeping unit (SKU) data, merchant codes, identification numbers/letters, or the like associated with the receipt. SKU data may be a unique identifier or code that refers to the products associated with a merchant. In some embodiments, the system may identify other information (along with the product identification) associated with the transaction, such as, but not limited to the merchant of the transaction, the payment vehicle used for the transaction, the purchase price of each product of the transaction, and the like from the collected receipt.

Next, as illustrated in block 418, the system may store the collected receipts and the information obtained from them in a repository for subsequent monitoring of promotions for the products of the receipts.

FIG. 6 illustrates a process map for rules input and application for the post-transaction receipt collection and product promotion monitoring 600, in accordance with one embodiment of the present invention. Rules for the post-transaction receipt collection and product promotion monitoring process may be determined from the user 202 input or from the system. In some embodiments, as illustrated in block 602, the user 202 may input user roles preferences. These preferences may be provided by the user 202 during set-up of the post-transaction receipt collection and product promotion monitoring process that aid the system in determining the product promotions to present to the user 202. These rules may include one or more rules based on time, product, or merchant (explained in further detail below with respect to block 604). In this way, the user 202 may be able to input rules for system monitoring of product promotions. These rules may relate to the time of promotion after the transaction, promotion amount, product type to monitor, merchant, or the like.

As illustrated in block 603, the system may set the rules for the post-transaction receipt collection and product promotion monitoring process. These preferences may be determined by the system based on the product, the merchant, or previously inputted user 202 preferences. For example, the system may determine that merchant A does not accept promotions for a product that has been purchased over thirty days ago. As such, the system may input a rule for that merchant that no products of a transaction may be monitored after thirty days from the transaction.

As illustrated in block 604, the rules for product promotion notification may include one or more time based rules 605, product based rules 606, and/or merchant based rules 608. In some embodiments, the rules may be set up at the monitoring stage of the process. In this way, the products of the transaction that trigger these rules will not be monitored for promotions associated with the product. In some embodiments, these rules may be implemented at the user 202 notification stage. In this way, the system may still monitor for promotions, but a rule may be triggered once a promotion is found, prior to the user 202 being notified of the promotion. In some embodiments, the time based rule 605 may allow a rule to be set for the monitoring of product promotions for a specific amount of time, such as days/weeks/months. In this way, the system may only monitor promotions for a specific amount of time after the transaction took place. For example, a rule may be set to only monitor for product promotions for 30 days after the transaction (this may be the amount of time the merchant will accept returns after a transaction). In this way, rules may include time periods for product return/exchange eligibility, such that if a product was purchased thirty/sixty/ninety days ago, it may not be eligible for a return or promotion price match. As such, after that amount of time has lapsed, the system may stop monitoring for product promotions and/or not notify the user 202 if a product promotion is identified.

In some embodiments, the rules for product promotion notification 604 may include product based rules 606. Product based rules 606 include rules that may be set regarding which products to monitor for promotions, which products are not eligible for promotions, promotion amount for a product, and/or the like. In some embodiments, the user 202 may select which products, such as categories of products that he/she may wish to be monitored for promotions. Categories may include, but are not limited to electronics, clothing, home improvement, services, and/or the like. In this way, the user 202 may select which types of products he/she desires to have monitored. In some embodiments, products may be based on the type of product, category of product, individual product, brand of product, or merchant associated with the product.

In some embodiments, product based rules 606 may include rules associated with products that are ineligible for returning/price matching. In this way, these products may not be monitored by the system because the merchant will not allow a return/price match for a product from a previous transaction. These products may typically include consumable goods, such as food, drinks, or the like. In this way, products that are not eligible for return post-transaction are eliminated from monitoring.

In some embodiments, product based rules 606 may include rules associated with promotion amounts for a product. As such, a rule may be set for the system to only notify the user 202 of promotions post-transaction that are over a specific amount or percentage off of what the user 202 purchased the product for.

In some embodiments, the rules for product promotion notification 604 may include merchant based rules 608. Merchant based rules 608 include rules for which merchants accept returns and/or price matches for products post-transaction. In this way, the system may determine, using the merchant bases rules 608, which merchant may accept a product promotion post-transaction. This may be the same merchant of the transaction or a separate merchant that accepts price matching or the like.

Next, as illustrated in block 610 of FIG. 6 the system may apply the rules to the product promotions that have been identified. If the product and/or product promotion has triggered one or more of the rules, the user 202 may not be notified of the product promotion. If the product promotion that was identified was not triggered by a rule, the system may notify the user 202 of qualifying product promotions that satisfy the rules, as illustrated in block 612. In this way, the user 202 may be allowed to return and/or exchange the product purchased for the same product with the product promotion. In this way, the user 202 may receive the benefit of the promotion post-transaction.

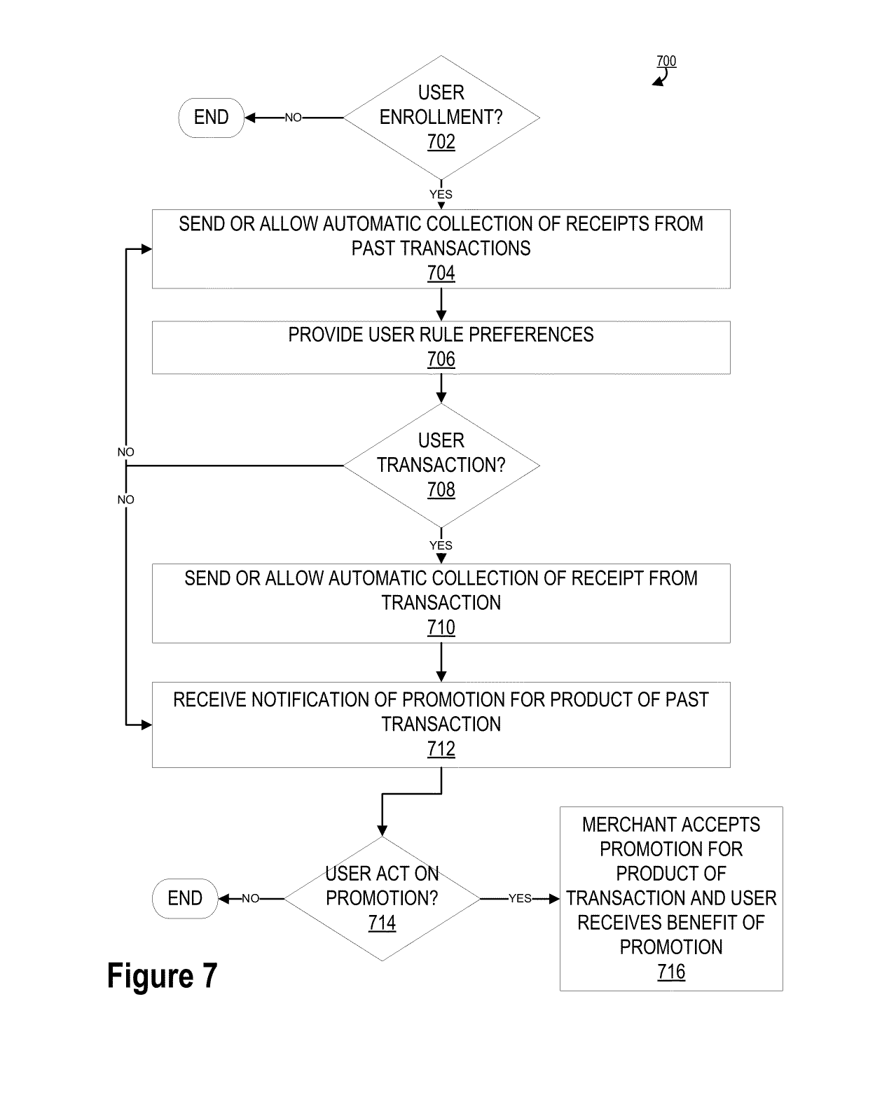

FIG. 7 illustrates a decision map for the user's implementation of the post-transaction receipt collection and product promotion monitoring process 700, in accordance with one embodiment of the present invention. As illustrated in decision block 702, the first step in the user's implementation of the post-transaction receipt collection and product promotion monitoring process 700 is to determine if the user 202 wishes to enroll in the process 700. Details regarding enrollment are disclosed in further detail about with respect to FIG. 3. If the user 202 does not enroll, then the process 700 is terminated. If the user 202 does enroll, the process 700 continues to allow the user to send or allow for automatic collection of receipts associated with user 202 transactions, as illustrated in block 704. This receipt collection may be from user 202 input, merchant input, or system request. This collection may be done via manual input or automatically.

Next, the user 202 may be able to provide user rule preferences to the system, as illustrated in block 706. Once rules and/or other user 202 preferences have been inputted, the user 202 may enter into a transaction with a merchant, as illustrated in decision block 708. If the user 202 does not enter into a transaction, the process 700 returns back to block 704 and continually allows for collection of receipts and user 202 rule input. Furthermore, in some embodiments, a product of a prior collected receipt may have a promotion and the user 202 may be notified of the promotion, as illustrated in block 712. If the user 202 does enter into a transaction in decision block 708, the process 700 continues to allow for the sending or automatic collection of the receipt from the transaction, as illustrated in block 710.

Next, as illustrated in block 712, the user 202 may receive notification of a promotion for a product of a past transaction. Once notified, the user 202 may decide in decision block 714 to act on the promotion. If the user 202 decides not to act on the promotion, the process 700 is terminated. If the user 202 decides in decision block 714 to pursue the promotion the merchant may accept the promotion for the product of the past transaction and the user 202 may receive the benefit of the promotion, as illustrated in block 716.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for post-transaction product promotion notification, the system comprising:
a memory device with computer-readable program code stored thereon;
a communication device;
a processing device operatively coupled to the memory device and the communication device, wherein the processing device is configured to execute the computer-readable program code to:
collect receipts from transactions between a user and a merchant, wherein the receipts are collected post-transaction;
determine one or more products of the transactions, wherein the one or more products are determined to be products of the transaction based on the collected receipts;
monitor, continuously, merchants for promotions associated with the one or more products of the transaction;
identify a promotion that corresponds to the one or more products of the transactions;
determine if the identified promotion is eligible for use for the one or more products of the transaction, wherein eligibility includes a capability to use the identified promotion after the transaction between the user and the merchant has taken place; and
notify the user of an eligible promotion and the one or more merchants that accept the eligible promotion.

2. The system of claim 1, wherein determining that the identified promotion is eligible for use at one or more merchants for the one or more products of the transaction further comprises determining if the one or more merchants accept utilization of the identified promotion after the one or more products have been purchased.

3. The system of claim 1 further comprising allowing the user to enroll, wherein enrollment authorizes the collection of receipts from transactions between the user and the merchant, wherein enrollment further comprises allowing setting up rules for notification of the user of eligible promotions.

4. The system of claim 1, wherein determining if the identified promotion is eligible for use for the one or more products of the transaction further comprises determining if the identified promotions satisfy rules, wherein the rules include one or more:
merchant based rules, wherein merchant based rules are rules established by merchant policy that determine if the identified promotion can be used after the transaction between the user and the merchant;
time based rules, wherein time based rules are rules that determine if the identified promotion can be used based on an amount of time that has passed since the transaction between the user and the merchant; or
product based rules, wherein product based rules are rules that determine if the one or more of the products of the transaction are eligible for promotions after the transaction between the user and the merchant has occurred.

5. The system of claim 1, wherein collecting receipts from transactions between a user and a merchant comprises receiving or retrieving receipts electrically from the user or the merchant via image capture.

6. The system of claim 1, wherein determining one or more products of the transaction further comprises identifying the one or more product using a stock keeping unit on the collected receipts.

7. The system of claim 1, wherein determining one or more products of the transaction further comprises determining a confidence score that the one or more products of the transaction determined from the collected receipts are a type, brand, and model of a real product of the transaction, wherein if the confidence is not high enough the user is contacted to confirm the type, brand, and model of the one or more products of the transaction.

8. The system of claim 1, wherein monitoring merchants for promotions associated with the one or more products of the transaction further comprises monitoring the merchant of the transaction and other merchants that promote the one or more products of the transaction.

9. The system of claim 1, wherein promotions comprise a discount in the price of the product of the transaction between the user and the merchant.

10. A computer program product for post-transaction product promotion notification, the computer program product comprising at least one non-transitory computer-readable medium having computer-readable program code portions embodied therein, the computer-readable program code portions comprising:
an executable portion configured for collecting receipts from transactions between a user and a merchant, wherein the receipts are collected post-transaction;
an executable portion configured for determining one or more products of the transactions, wherein the one or more products are determined to be products of the transaction based on the collected receipts;
an executable portion configured for monitoring, continuously, merchants for promotions associated with the one or more products of the transaction;
an executable portion configured for identifying a promotion that corresponds to the one or more products of the transactions;
an executable portion configured for determining if the identified promotion is eligible for use for the one or more products of the transaction, wherein eligibility includes a capability to use the identified promotion after the transaction between the user and the merchant has taken place; and
an executable portion configured for notifying the user of an eligible promotion and the one or more merchants that accept the eligible promotion.

11. The computer program product of claim 10, wherein determining that the identified promotion is eligible for use at one or more merchants for the one or more products of the transaction further comprises determining if the one or more merchants accept utilization of the identified promotion after the one or more products have been purchased.

12. The computer program product of claim 10 further comprising an executable portion configured for allowing the user to enroll, wherein enrollment authorizes the collection of receipts from transactions between the user and the merchant, wherein enrollment further comprises allowing setting up rules for notification of the user of eligible promotions.

13. The computer program product of claim 10, wherein determining if the identified promotion is eligible for use for the one or more products of the transaction further comprises determining if the identified promotions satisfy rules, wherein the rules include one or more:
merchant based rules, wherein merchant based rules are rules established by merchant policy that determine if the identified promotion can be used after the transaction between the user and the merchant;
time based rules, wherein time based rules are rules that determine if the identified promotion can be used based on an amount of time that has passed since the transaction between the user and the merchant; or
product based rules, wherein product based rules are rules that determine if the one or more of the products of the transaction are eligible for promotions after the transaction between the user and the merchant has occurred.

14. The computer program product of claim 10, wherein determining one or more products of the transaction further comprises identifying the one or more product using a stock keeping unit on the collected receipts.

15. The computer program product of claim 10, wherein determining one or more products of the transaction further comprises determining a confidence score that the one or more products of the transaction determined from the collected receipts are a type, brand, and model of a real product of the transaction, wherein if the confidence is not high enough the user is contacted to confirm the type, brand, and model of the one or more products of the transaction.

16. A computer-implemented method for post-transaction product promotion notification, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
collecting receipts from transactions between a user and a merchant, wherein the receipts are collected post-transaction;
determining one or more products of the transactions, wherein the one or more products are determined to be products of the transaction based on the collected receipts;
monitoring, continuously, merchants for promotions associated with the one or more products of the transaction;
identifying a promotion that corresponds to the one or more products of the transactions;
determining, via a computer processing device, if the identified promotion is eligible for use for the one or more products of the transaction, wherein eligibility includes a capability to use the identified promotion after the transaction between the user and the merchant has taken place; and
notifying the user of an eligible promotion and the one or more merchants that accept the eligible promotion.

17. The computer-implemented method of claim 16, wherein determining that the identified promotion is eligible for use at one or more merchants for the one or more products of the transaction further comprises determining if the one or more merchants accept utilization of the identified promotion after the one or more products have been purchased.

18. The computer-implemented method of claim 16 further comprising allowing the user to enroll, wherein enrollment authorizes the collection of receipts from transactions between the user and the merchant, wherein enrollment further comprises allowing setting up rules for notification of the user of eligible promotions.

19. The computer-implemented method of claim 16, wherein determining if the identified promotion is eligible for use for the one or more products of the transaction further comprises determining if the identified promotions satisfy rules, wherein the rules include one or more:
merchant based rules, wherein merchant based rules are rules established by merchant policy that determine if the identified promotion can be used after the transaction between the user and the merchant;
time based rules, wherein time based rules are rules that determine if the identified promotion can be used based on an amount of time that has passed since the transaction between the user and the merchant; or
product based rules, wherein product based rules are rules that determine if the one or more of the products of the transaction are eligible for promotions after the transaction between the user and the merchant has occurred.

20. The computer-implemented method of claim 16, wherein determining one or more products of the transaction further comprises identifying the one or more product using a stock keeping unit on the collected receipts.

21. The computer-implemented method of claim 16, wherein determining one or more products of the transaction further comprises determining a confidence score that the one or more products of the transaction determined from the collected receipts are a type, brand, and model of a real product of the transaction, wherein if the confidence is not high enough the user is contacted to confirm the type, brand, and model of the one or more products of the transaction.
